(19) United States
(12) Patent Application Publication
(10) Pub. No.: US 2013/0091060 A1
(43) Pub. Date: Apr. 11, 2013

(54) System and method for configuring risk tolerance in transaction cards

(71) Applicant: Arindam Kundu, Fremont, CA (US)

(72) Inventor: Arindam Kundu, Fremont, CA (US)

(73) Assignee: BLACKHAWK NETWORK, INC., Pleasanton, CA (US)

(21) Appl. No.: 13/704,084

(22) PCT Filed: Jun. 10, 2011
(86) PCT No.: PCT/US11/39996

§ 371 Date: Dec. 13, 2012

Related U.S. Application Data
(60) Provisional application No. 61/360,326, filed on Jun. 30, 2010.
(60) Provisional application No. 61/354,474, filed on Jun. 14, 2010.

(51) Int. Cl. G06Q 20/34

(52) U.S. Cl. CPC G06Q 20/354
USPC 705/44

(57) ABSTRACT

A method comprising receiving a security profile configurable by a card party, storing the security profile in a database, receiving a transaction request to activate a transaction card, determining whether the transaction request satisfies the security profile's one or more requirements.

### CROSS-REFERENCE TO RELATED APPLICATIONS

This application is a filing under 35 U.S.C. 371 of International Application No. PCT/US2011/039996 filed Jun. 10, 2011, entitled “System and Method for Configuring Risk Tolerance in Transaction Cards,” which claims priority to U.S. Provisional Patent Application Nos. 61/354,474 filed on Jun. 14, 2010 and 61/360,326 filed on Jun. 30, 2010, which applications are incorporated by reference herein in their entirety.

### FIELD OF INVENTION

The present invention generally relates to a processing and activation system providing card parties with the ability to configure risk tolerance for each transaction card, e.g. gift cards, debit cards, and credit cards, program that is created.

### BACKGROUND OF INVENTION

The market for transaction cards such as merchant gift cards continues to grow. With the growth of the transaction card market, fraud involving stored-value cards has increased. Additionally, card parties have previously been unable to easily configure their stored-value card programs to address the increasing fraud to suit each card party's own risk tolerance. Accordingly, it is desirable to develop a system and method that allows card parties to easily configure their stored-value card programs to address fraud.

### SUMMARY

The problems noted above are solved in large part by a method that comprises: receiving a security profile associated with and configurable by a card party, storing the security profile in a database, receiving a transaction request from a point of sale to activate a transaction card associated with the card party, determining whether the transaction request satisfies a first requirement stored in the security profile, activating the transaction card based on the determination indicating that the transaction request satisfies the first requirement, and transmitting an indication of the activation of the transaction card to the point of sale.

Another illustrative embodiment includes a system that comprising a database and a processor. The processor is configured to receive a security profile associated with and configurable by a card party, store the security profile in the database, receive a transaction request from a point of sale to activate a transaction card associated with the card party, determine whether the transaction request satisfies a first requirement stored in the security profile, activate the transaction card based on the determination indicating that the transaction request satisfies the first requirement, and transmit an indication of the activation of the transaction card to the point of sale.

Yet another illustrative embodiment includes a computer-readable medium encoded with a computer program comprising instructions that when executed cause one or more processors to: receive a security profile associated with and configurable by a card party, store the security profile in the database, receive a transaction request from a point of sale to activate a transaction card associated with the card party, determine whether the transaction request satisfies a first requirement stored in the security profile, activate the transaction card based on the determination indicating that the transaction request satisfies the first requirement, and transmit an indication of the activation of the transaction card to the point of sale.

### BRIEF DESCRIPTION OF THE DRAWINGS

For a detailed description of various disclosed embodiments, reference will now be made to the accompanying drawings in which:

FIG. 1 is a front perspective view of a representative individual transaction card;

FIG. 2 is a front perspective view of a package assembly for securing one or more individual transaction cards;

FIG. 3 is a schematic representation of a transaction card transaction system;

FIG. 4 is a schematic representation of a security profile stored in a database of the transaction card transaction system; and

FIG. 5 shows an illustrative flow diagram of a method implemented in accordance with embodiments of the invention.

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct electrical connection. Thus, if a first device couples to a second device, that connection may be through a direct electrical connection, or through an indirect electrical connection via other devices and connections.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to suggest that the scope of the disclosure, including the claims, is limited to that embodiment.

As used herein, transaction card refers to a card that may be used to transact business with a party willing to accept the card, for example as tender for a purchase. Examples of such cards include credit cards, debit cards, gift cards, telephone cards, loyalty cards, membership cards, ticket cards, entertainment cards, sports cards, prepaid cards, stored-value cards, and the like. Typically, such cards are wallet-sized and made of plastic, but could be of any size or shape and also could be wholly electronic and/or virtual. In various embodiments, the transaction card may be a type of card such as a gift or prepaid card that requires activation at a point of sale. For example, a transaction card may be purchased and activated at a point of sale by a consumer and subsequently used by the consumer or another (e.g., the recipient of the card as a gift) to transact business.

Consumer use of transaction cards typically involves a card vendor, a redeeming merchant, a transaction facilitator, a transaction processor, a card processor, and a card issuer (generally, “card party”). In various embodiments, the card vendor, redeeming merchant, the transaction facilitator, the transaction processor, the card processor, and the card issuer may be the same, different, related entities, or combinations thereof. The point of sale where transaction cards are purchased and activated may be referred to as the card vendor or simply vendor. An entity that will accept a transaction card for business transactions, for example as tender for a purchase, may be referred to as a redeeming merchant. An entity that provides a means for other card parties to communicate concerning a transaction card transaction may be referred to as a transaction facilitator. An entity that provides card parties information, validation and/or authorization for card transactions may be referred to as a transaction processor. An entity that provides the financial backing via the transaction card may be referred to as the card issuer or simply issuer. An entity that manages card transactions for a card issuer may be referred to as a card processor.

Typically, the issuer is identified on the transaction card and associates a unique issuer account code with each transaction card. Card issuers include direct issuers of cards such as store-branded cards, and in some embodiments the card vendor may also be the card issuer and/or the redeeming merchant. Card issuers also include banks, financial institutions, and transaction processors such as VISA, MasterCard, American Express, etc., and cards issued by such institutions may be readily accepted by a number of redeeming merchants to conduct transactions such as purchases. In some instances, the redeeming merchant may be identified on the transaction card (for example, a retailer branded card such as Store X), and such cards may be sold at the same or different card vendor (e.g., card vendor is Store X or a different or unrelated Store Z). In such instances, the Store X branded transaction card may be issued by Store X, by Store Z, or by a third party such as bank or financial institution.

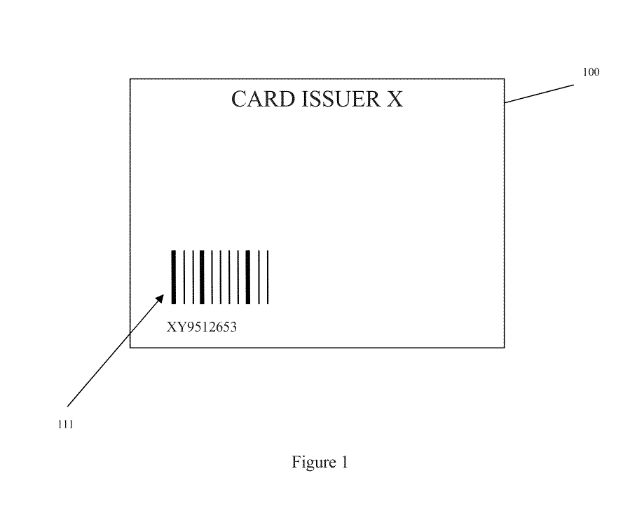

FIG. 1 depicts transaction card 100. The transaction card 100 is fabricated from a suitable first material, such as plastic, paper, a plastic-coated paper, laminates, or combinations thereof. The transaction card 100 is typically made in a thickness range of from about 0.005 to about 0.040 inch. The transaction card 100 bears an identifier 111. The transaction card identifier 111 is unique to the transaction card and associates the transaction card to a unique account maintained by the card issuer. The transaction card identifier may be encoded in a bar code, a magnetic strip, a series of numerals, a series of letters, or a combination thereof. The transaction card 100 may also be fashioned with a personal identification number, or PIN, to be entered during the course of a transaction, that corresponds to the transaction card identifier 111 and allows access and/or use of the transaction card account. The PIN may be encoded in a bar code, a magnetic strip, a series of numerals, a series of letters, or a combination thereof.

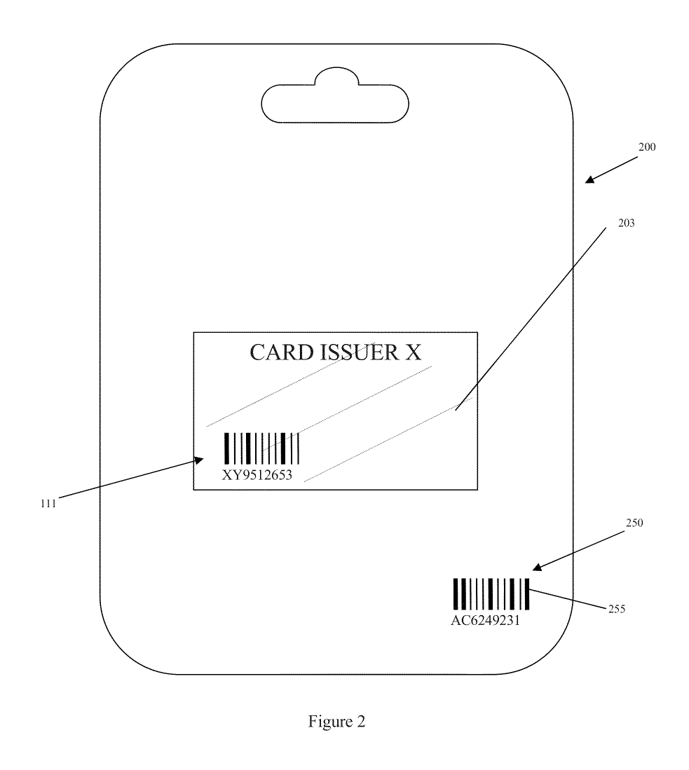

FIG. 2 depicts a package 200 associated with transaction card 100. Package 200 is distinct and separate from the transaction card 100. Package 200 may be formed from paper, plastic, plastic-coated paper, laminate, or combinations thereof. For example, the package may be made of a 15 point coated one-side board stock, although it may be a laminated board or other laminate. Preferably, if the package secures a transaction card comprising a PIN, the package backing material is opaque, to obscure the PIN on the transaction card 100, as described above. A transparent shrink wrap plastic film 203, applied using well-known methods, may be used to cover the transaction card 100 and to secure the transaction card 100 to package 200. In the alternative, a transparent plastic cover with an appropriately sized, generally rigid, embossed area accommodating the transaction card 100 may be incorporated, forming a structure commonly known as a “blister pack”. Package 200 may be imprinted with decorations, advertising, coupons, instructions, or other information as will now be apparent to those skilled in the art. Package 200 is presented for illustrative purposes only. Package assemblies could be constructed to secure 2, 3, 4, or any plurality of transaction cards, from any number of affiliated or non-affiliated card issuers. Additionally, package assemblies could be fashioned from any industry-accepted material with individual transaction cards secured in any industry-accepted manner. Furthermore, these packages could be formed or constructed in a plurality of shapes or presentations comprising a plurality of decorative, informational, promotional, or other information as would be apparent to those skilled in the art.

The package 200 bears an identifier 250. The package identifier 250 is unique to the package and is linked to the transaction card 100, and any other transaction card that is secured by package 200. More specifically, package identifier 250 is linked to the transaction card identifiers secured by the package. The package identifier 250 may be encoded in a bar code, a magnetic strip, radio frequency identification (RFID) tags, microprocessors, microchips, a series of numerals, a series of letters, or a combination thereof. The package identifier 250 may be positioned anywhere on the package 200 whereby it is capable of being interpreted by a point of sale interpretation component 301.

In an embodiment of the package identifier 250, the package 200 comprises a bar code 255 of conventional construction, such as a UPC code, positioned on the package 200 so that it can be scanned by well-known bar code reading equipment. Encoded in the bar code 255 on the package is a representation of the package identifier.

In another embodiment of the package identifier (not shown), the package 200 comprises a magnetic strip of conventional construction, such as one deposited from a slurry, positioned on the package 200 so that it can be scanned in well-known magnetic strip reading equipment. A terminal such as a Tranz 380 made by Verifone is suitable in this application. The magnetic strip may be encoded with a representation of the package identifier. For additional security, the package identifier may also be subjected to an encryption algorithm, many of which are well-known in the art, prior to encoding on the magnetic strip.

In other embodiments of the package identifier (not shown), radio frequency identification (RFID) tags, microprocessors, microchips may be placed on the package 200 to be interpreted by specifically configured devices.

In further embodiments, series of numerals, series of letters, or combinations thereof, may be placed on the package 200 to be read or interpreted by a human or a device, i.e. optical character recognition device, configured to interpret a series of shapes corresponding to the package identifier.

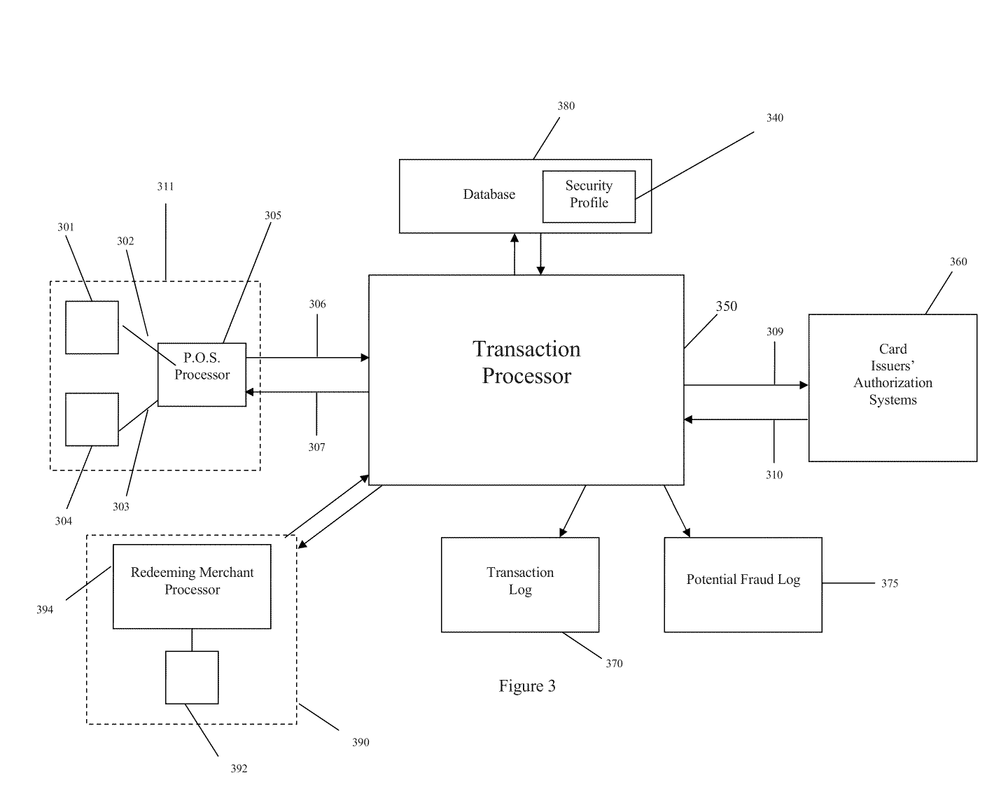

FIG. 3 illustrates a transaction card transaction system 300 in accordance with the present invention. Prior to an activation request to activate a transaction card, a card party may establish a security profile 340. The card party may designate certain security information that comprise requirements that an activation transaction or a request to transact business (e.g. tender for a purchase from a redeeming merchant or withdrawal of cash from a redeeming merchant using a transaction card) must satisfy in order for the transaction to be approved. These designations are saved in the security profile 340 which may be stored in database 380. The card parties' systems (e.g., card vendors' systems, redeeming merchants' systems, transaction facilitators' systems, transaction processors' systems, card processors' systems, and/or card issuers' systems) are configurable to communicate with transaction processor 350 in order to store security profile 340 in database 380. The card parties' systems may comprise one or more CPUs or other type of processing device which has an ability to communicate over a network with other computer systems.

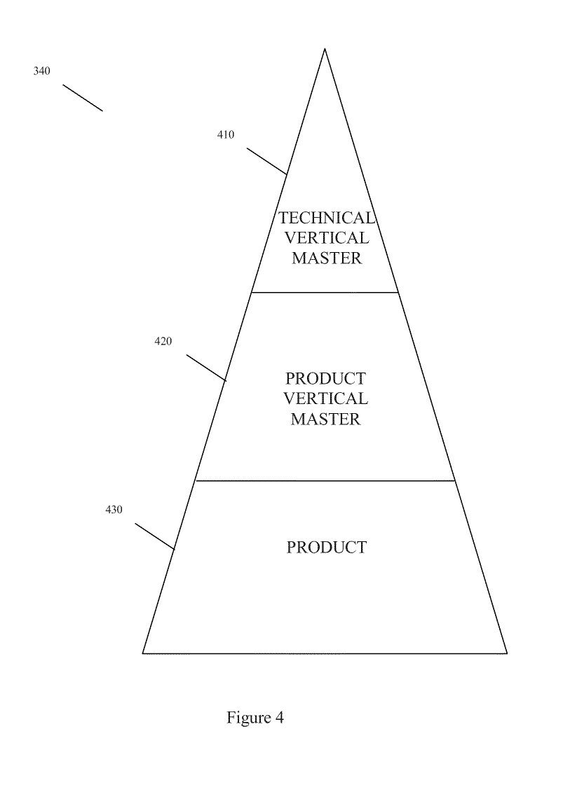

FIG. 4 illustrates the security profile 340. The security profile 340 may have a three level hierarchy including: a Technical Vertical Master 410, a Product Vertical Master 420, and a Product 430. The Technical Vertical Master 410 stores the boundary of requirements that an entire product line must satisfy in order for an activation request or a request to transact business be approved. For example, the Technical Vertical Master 410 may have requirements that a Store X branded transaction card must satisfy in order for an activation request to be approved.

Card program configuration may originate at the Technical Vertical Master 410 level and cascade down to the Product Vertical Master 420 level and Product 430 level depending on the instant configuration scenario.

The Product Vertical Master 420 contains requirements that specific program within the product line must satisfy in order for an activation request or a request to transact business be approved. The product vertical master 420 may inherit the requirements stored in the technical vertical master 410. For example, the product vertical master 420 may have requirements for Store X branded non-reloadable transaction cards (transaction cards that cannot have funds added) that must be satisfied in order for an activation request to be approved. These types of transaction cards would also have the requirements that are stored in the technical vertical master 410 for all Store X branded transaction cards.

Examples of Product Vertical Master 420 categories comprise: Card Expiration or Replacement; Activation; Network Transaction Fees; Account Management Fees; Fraud Prevention; and Confirmation.

The Card Expiration or Replacement category may comprise several sub-categories such as: Expiration Type/Date (Static—sets the expiration date for all cards created at a defined future date and Rolling—sets the expiration date for all cards at a defined period from the date they were created); Allow Reissue of Plastics (flag indicates whether the program allows for the reissue of cards (same card number and same expiration date as the card being reissued, but with a different card verification value “CVV”)); Allow Replacement of Plastics (flag indicates whether the program allows for the replacement of cards (new card number, new expiration date, and new CVV)); Auto-Renewal (allows cards to be systematically reissued X number of days and/or months prior to expiration); and Allow Advanced Expire for Replacement Cards (allows for the extension of the expiration date of a card that has been issued as a replacement card).

The Activation category may comprise sub-categories such as: Allow Manual Activation by a Customer Service Representative (enables a card issued to be activated by a customer service representative (“CSR”) upon the cardholder contacting the CSR for assistance); and Support Delayed Activation (a fraud prevention measure that prevents a card from being used within a configurable time period from the initial sale).

The Network Transaction Fees category may comprise sub-categories such as: Currency Conversion (configurable fee applied when a transaction is performed in a currency other than the default currency—may be charged as a percentage of the amount of the settled transaction); and Take Negative for Fee (allows an account to be taken to a negative balance should the account balance not support the applied fee).

The Account Management Fees category may comprise sub-categories such as: Monthly Service Fee (related to fees assessed after a configurable amount of time has passed from the card sale date—configurable e.g., concerning amount of fee, ability to take an account negative for a fee assessment, date/day for fee application, and/or delay period for assessing a fee); Card Reissue Fee (fee assessed for the reissuance of a previously registered card—configurable e.g., concerning amount of fee and/or ability to take an account negative for a fee assessment); Card Reissue Expedite Fee (fee assessed to hasten the reissue of a previously registered card—configurable e.g., concerning amount of fee and/or ability to take an account negative for a fee assessment); Card Replace Fee (fee assessed to replace a previously registered card—configurable e.g., concerning amount of fee and/or ability to take an account negative for a fee assessment); Card Replace Expedite Fee (fee assessed to hasten the replacement of a previously registered card—configurable e.g., concerning amount of fee and/or ability to take an account negative for a fee assessment); and Refund Fee (fee assessed to remit payment to a card holder for the remaining account balance of a card—configurable e.g., concerning amount of fee).

The Fraud Prevention category may comprise sub-categories such as: Tolerances (percentages or amounts that may be added to an initial card authorization request—configurable e.g., concerning tips or other instances wherein additional amounts are added to an initial amount resulting in a final authorization amount); and Authorization Hold Times (an amount of time that an authorized, but not settled, transaction may be held against an account prior to the expiration of authorization—configurable e.g., for merchant categories and default hold times); Balance Control Limits (such as a minimum and/or maximum allowable balance for an account—configurable e.g., for initial account opening and long term account existence); Velocity Limits (define the maximum spend amount that may be performed on an account in a defined period of time—configurable e.g., for spend amounts, number of transactions, location of transactions, and time periods); Usage (concerns restrictions placed on card and/or account usage—configurable e.g., Country Codes, Merchant Category Codes, and Merchant Identification Numbers).

The Confirmation category allows a card party to approve or discard the configuration of the Product Vertical Master 420.

The Product 430 inherits the program attributes, e.g., categories, that are defined at the Product Vertical Master 420, as described above. As with the Product Vertical Master 420 categories, the Product's 430 categories are likewise configurable by a card party.

The product 430 contains requirements that a specific transaction card within the product line must satisfy in order for an activation request or a request to transact business be approved. The product 430 may inherit the requirements stored in the technical vertical master 410 and the product vertical master 420. For example, the product 430 may have requirements for a Store X branded $50 non-reloadable transaction card that must be satisfied in order for an activation request to be approved. These types of transaction cards would also have the requirements that are stored in the technical vertical master 410 for all Store X branded transaction cards as well as the requirements stored in the product vertical master 420 for all Store X branded non-reloadable transaction cards.

The security profile 340 is fully configurable by a card party. Thus, the card party may, through the card party's system, may change or update any requirement stored in any of the three levels of hierarchy stored in security profile 340 at any time. The card party may, through the card party's system, add additional requirements to or delete any requirement from any of the three levels of hierarchy stored in security profile 340 at any time. This enables each card issuer to determine its level of risk.

The requirements that the card party may designate through the card party's system to the security profile 340 in any one of the three levels of hierarchy may include: that any request for activation of the transaction card 100 be declined if any attempt has previously been made to transact business utilizing transaction card 100. Additionally, the card party may require a certain time delay between the activation of the transaction card 100 and the ability to transact business. Additional requirements that may be included in any of the three levels of hierarchy in the security profile 340 include: country codes (countries where the transaction card 100 may be activated or where requests to transact business may be authorized), merchant identification numbers (redeeming merchants that transaction card 100 may be authorized to transact business), and merchant category codes (categories of redeeming merchants that transaction card 100 may be authorized to transact business). Other additional requirements may be included in any of the three levels of hierarchy in the security profile 340 as well.

Referring again to FIG. 3, in order to activate the transaction card 100, at the point of sale, the package identifier 250 is interpreted 302 by a point of sale interpretation component 301. The point of sale interpretation component 301 can comprise a human, a bar code scanner, magnetic strip reader, optical character recognition device, or other device configured to interpret the data encoded in the package identifier. While the point of sale interpretation component 301 may interpret package identifier 250, it may also interpret transaction card identifier 111 or any other identifier associated with a transaction card.

Contemporaneously with the interpretation of the package identifier 250, transaction card identifier 111, or any other identifier associated with a transaction card, a request for activation 303 by a point of sale transaction component 304 is made. The point of sale transaction component 304 can comprise a human, an electronic input device, a register, a central processing unit (“CPU”), or other means of requesting the activation of the package identifier, transaction card identifier, or other identifier associated with a transaction card interpreted by the point of sale interpretation component 301. For purposes of disclosure, the actions performed by the point of sale interpretation component 301 and the point of sale transaction component 304 may be performed by one component capable of performing both actions that would be performed by the individual components.

The point of sale interpretation component 301 and the point of sale transaction component 304 communicate with the point of sale processing component 305. The point of sale processing component 305 can comprise a CPU or other type of processing device accepted for use in the industry. The point of sale interpretation component 301 communicates the package identifier 250, transaction card identifier 111, or any other identifier associated with a transaction card to the point of sale processing component 305. The point of sale transaction component 304 communicates the request for activation of the package identifier 250, transaction card identifier 111, or any other identifier associated with a transaction card interpreted by the point of sale interpretation component 301 to the point of sale processing component 305. The point of sale processing component 305 correlates the package identifier 250, transaction card identifier 111, or any other identifier associated with a transaction card interpreted by the point of sale interpretation component 301 with the request for activation made by the point of sale transaction component 304 and communicates the request 306 for activation of the package identifier 250, transaction card identifier 111, or any other identifier associated with a transaction card to the transaction computer 350. For purposes of disclosure, the actions performed by the point of sale interpretation component 301, the point of sale transaction component 304, and the point of sale processing component 306 may all be performed by one component capable of performing all the actions that would be performed by the individual components.

The point of sale processing component 305 is connectable to the transaction computer 350 via a suitable network, such as the public switched telephone network (PSTN) or an independent dedicated network. Each point of sale processing component 305 has an associated identifier that may be transmitted to the transaction computer 350 during the course of connecting the point of sale processing component 305 to the transaction computer 350.

The transaction computer 350 may comprise a singular processing unit, with concomitant storage capability, capable of accessing a database 380, creating and maintaining a transaction log 370, creating and maintaining a potential fraud log 375, communicating with card vendors, communicating with the individual card issuers' authorization systems 360, processing individual transaction card activation requests, communicating with redeeming merchant processor systems 390, and processing individual transaction card requests to transact business.

In the alternative, the transaction computer may comprise a plurality of processing units, with concomitant storage capabilities, each capable of: accessing the database 380; creating a transaction log 370; creating and maintaining a potential fraud log 375; communicating with card vendors; communicating with the individual card issuers' authorization systems 360; processing individual transaction card activation requests, communicating with redeeming merchant processor systems 390, and processing individual transaction card requests to transact business.

Upon receipt of an activation request for a package 200 securing a transaction card or multiple transaction cards or a request for activation of the transaction card 100 from the card vendor, the transaction computer 350 accesses the security profile 340 stored in database 380. The transaction computer 350 processes the information contained in the security profile 340 and determines whether all of the requirements for activation stored in the security profile 340 are satisfied by the particular transaction card or multiple transaction cards secured by package 200 or the transaction card 100.

If the requirements for activation stored in security profile 340 are satisfied, transaction processor 350 is configured to proceed with the activation of the transaction card or transaction cards secured by package 200 or transaction card 100 and communicate to the card vendor 307, upon the activation of the transaction card, that the activation of the package 200 or transaction card 100 is complete and to communicate any necessary PIN information required by activated transaction cards to the card vendor in order for the card purchaser to be apprised of that information for use of the purchased individual transaction card. Once transaction card 100 is activated, requests to transact business utilizing transaction card 100 may occur.

If the requirements for activation stored in the security profile 340 are not satisfied, transaction processor 350 is configured to decline activation of the transaction card or transaction cards secured by package 200 or transaction card 100 and communicate to the card vendor 307 that the activation was declined. If the activation of transaction card 100 is declined, then transaction card 100 may not be utilized to transact business.

In order to transact business utilizing transaction card 100, a redeeming merchant 390 uses a redeeming merchant transaction component 392 to initiate a request to transact business. The redeeming merchant transaction component 392 can comprise a human, an electronic input device, a register, a central processing unit (“CPU”), or other means of requesting to transact business utilizing transaction card 100. The redeeming merchant transaction component 392 communicates the request to transact business to the redeeming merchant processing component 394. The redeeming merchant processing component 394 communicates the request to transact business utilizing the transaction card 100 to the transaction computer 350. For purposes of disclosure, the actions performed by the redeeming merchant transaction component 392 and the redeeming merchant processing component 394 may be performed by one component capable of performing all the actions that would be performed by each individual component.

The redeeming merchant processing component 394 is connectable to the transaction computer 350 via a suitable network, such as the public switched telephone network (PSTN) or an independent dedicated network. Each redeeming merchant processing component 394 has an associated identifier that may be transmitted to the transaction computer 350 during the course of connecting the redeeming merchant processing component 394 to the transaction computer 350.

Upon receipt of request to transact business utilizing transaction card 100, the transaction computer 350 accesses the security profile 340 stored in database 380. The transaction computer 350 processes the information contained in the security profile 340 and determines whether all of the requirements for transacting business stored in the security profile 340 are satisfied by the transaction card 100.

If the requirements for transacting business stored in security profile 340 are satisfied, transaction processor 350 is configured to proceed with the authorization of the business transaction and communicate to the redeeming merchant 390, upon authorization, that the business transaction is authorized. If the requirements for transacting business stored in the security profile 340 are not satisfied, the transaction processor 350 is configured to decline the request to transact business and communicate to the redeeming merchant 390 that the request to transact business was declined.

The transaction computer 350 is configured to generate and maintain a transaction log 370 of all activity involving the transaction computer 350. The transaction log may comprise a detailed summary of: (a) requested package activations; (b) requested package deactivations; (c) requested individual card activations; (d) requested individual card deactivations; (e) the monetary amount ascribed to package activations; (f) the monetary amount ascribed to package deactivations; (g) the monetary amounts ascribed individual transaction card activations; (h) the monetary amounts ascribed to individual transaction cards deactivations; (i) the identities of the individual card issuers of the transaction cards secured by activated packages; (j) the identities of the individual card issuers of the transaction cards secured by deactivated packages; (k) the time the packages were activated; (l) the time the packages were deactivated; (m) the time individual transaction cards were activated; (n) the time individual transaction cards were deactivated; (o) the transaction or communication performed with the card issuer to activate the individual transaction cards; (p) the transaction or communication performed with the card issuer to deactivate the individual transaction cards; (q) the PIN communicated to the card vendor in response to a request to activate a transaction card requiring the input of a PIN for use; (r) all activities involving the security profile 340; (s) potential fraud incidents for all activation requests and requests to transact business that were declined (to be maintained in a Potential Fraud Log 375); and (t) any combination thereof.

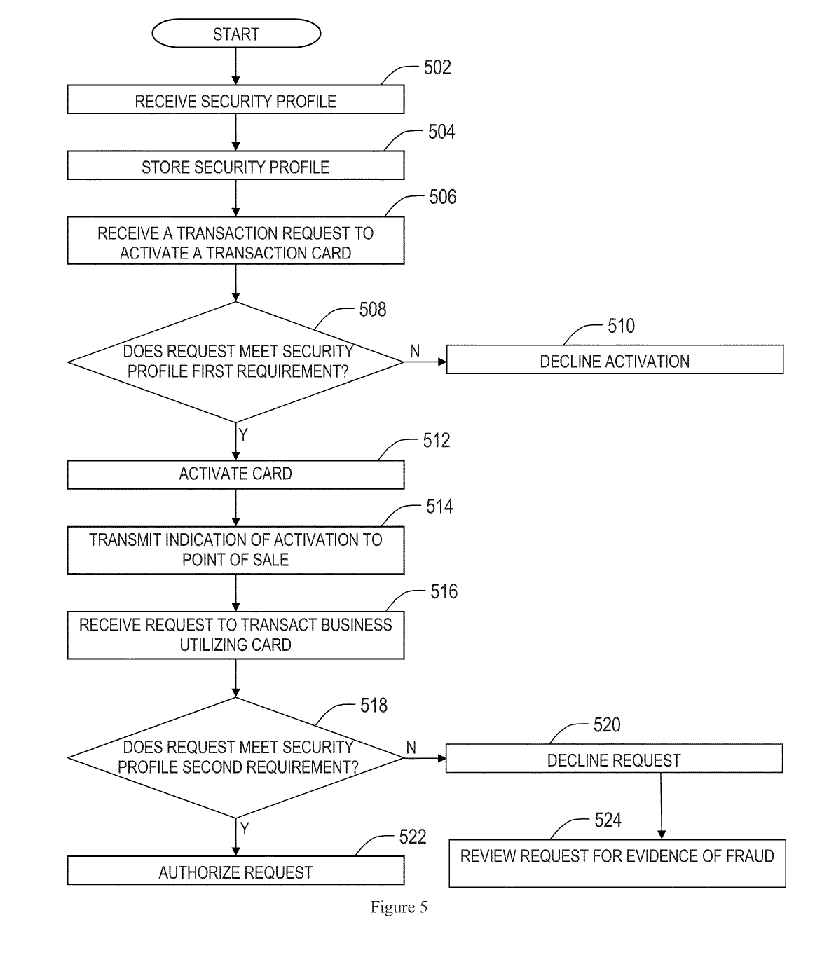

FIG. 5 shows an illustrative flow diagram of a method implemented in accordance with various embodiments of the invention. The method comprises, in block 502, receiving a security profile. The security profile may have a three level hierarchy including: a technical vertical master, a product vertical master, and a product. The technical vertical master stores the boundary of requirements that an entire product line must satisfy in order for an activation request or a request to transact business be approved. The product vertical master contains requirements that specific program within the product line must satisfy in order for an activation request or a request to transact business be approved. The product vertical master may inherit the requirements stored in the technical vertical master. The product contains requirements that a specific transaction card within the product line must satisfy in order for an activation request or a request to transact business be approved. The product may inherit the requirements stored in the technical vertical master and the product vertical master. The security profile is fully configurable by a card party. The requirements that the card party may designate on the security profile in any one of the three levels of hierarchy may include: that any request for activation of a transaction card be declined if any attempt has previously been made to transact business utilizing the transaction card. Additionally, the card party may require a certain time delay between the activation of the transaction card and the ability to transact business. Additional requirements that may be included in any of the three levels of hierarchy in the security profile include: country codes (countries where the transaction card may be activated or where requests to transact business may be authorized), merchant identification numbers (redeeming merchants that transaction card may be authorized to transact business), and merchant category codes (categories of redeeming merchants that transaction card may be authorized to transact business). Other additional requirements may be included in any of the three levels of hierarchy in the security profile as well, as more fully detailed above.

The method continues in block 504 with the storing of the security profile. Typically, the security profile is stored in a database which is coupled to a transaction processor. In block 506, the method also comprises receiving a transaction request. Generally, the transaction request is a request to activate a transaction card which is generated at a point of sale and is associated with a specific card issuer's transaction card. However, a request to activate multiple transaction cards from either the same card issuer or multiple card issuers may also be received.

The method also comprises, in block 508, a determination of whether the transaction request satisfies a first requirement stored in the security profile. This first requirement may be that no attempt has previously been made to transact business utilizing the transaction card. It may also be any other requirement that is stored in the security profile. If the first requirement is not satisfied, then the transaction request is declined, as illustrated in block 510. However, if the first requirement is satisfied, then the transaction request is allowed. Thus, if the transaction request is a request to activate a transaction card, the card is activated if the first requirement stored in the security profile is satisfied as illustrated in block 512. The method continues in block 514 with transmitting an indication of activation to the point of sale.

The method also comprises, in block 516, receiving a request to transact business utilizing the transaction card. This request generally is received from a redeeming merchant. In block 518, a determination is made as to whether the request to transact business satisfies a second requirement stored in the security profile. The second requirement may be a time delay between the time of activation of the transaction card and the time of receiving the request to transact business, a country code, a merchant identification number, or a merchant category code.

If the second requirement is satisfied, then the request to transact business is approved as illustrated in block 522. However, if the second requirement is not satisfied, the request to transact business is declined as illustrated in block 520 and is reviewed for evidence of fraud as illustrated in block 524.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

1. A method comprising:
receiving a security profile configurable by a card party, wherein the security profile comprises one or more requirements;
storing the security profile in a database;
receiving a request to activate a transaction card;
determining whether the request satisfies the security profile's one or more requirements.

2. The method of claim 1, wherein the one or more requirements is selected from the group consisting of:
no attempt has previously been made to transact business utilizing the transaction card;
a time delay between time of activation of the transaction card and time of receiving the request to transact business;
a country code;
a merchant identification number; and
a merchant category code.

3. The method of claim 2 further comprising:
activating the transaction card based on the determination that the request satisfies the one or more requirements; and
transmitting an indication of the activation of the transaction card.

4. The method of claim 2 further comprising:
declining to activate the transaction card based on the determination that the request does not satisfy at least one of the one or more requirements; and
transmitting an indication of the declining to activate the transaction card.

5-10. (canceled)

11. The method of claim 1, 5, or 8, wherein the security profile is configurable with requirements for all transaction cards issued by a card issuer.

12. The method of claim 1, 5, or 8, wherein the security profile is configurable with requirements for all transaction cards issued by a card issuer in a specific card program.

13. The method of claim 1, 5, or 8, wherein the security profile is configurable with requirements for each specific transaction card issued by a card issuer.

14. A system comprising:
a database; and
a processor configured to:
receive a security profile associated with and configurable by a card party, wherein the security profile comprises one or more requirements;
store the security profile in the database;
receive a request to activate a transaction card;
determine whether the request satisfies the security profile's one or more requirements;
activate the transaction card based on the determination that the request satisfies the one or more requirements; and
transmit an indication of the activation of the transaction card.

15. The system of claim 14, wherein the one or more requirements is selected from the group consisting of:
no attempt has previously been made to transact business utilizing the transaction card;
a time delay between time of activation of the transaction card and time of receiving the request to transact business;
a country code;
a merchant identification number; and
a merchant category code.

16. The system of claim 15, wherein the processor is further configured to:
receive a request to transact business utilizing the transaction card;
determine whether the request to transact business satisfies the security profile's one or more requirements; and
approve the request to transact business based on the determination that the one or more requirements has been satisfied.

17. The system of claim 15, wherein the processor is further configured to:
receive a request to transact business utilizing the transaction card;
determine whether the request to transact business satisfies the security profile's one or more requirements; and
decline the request to transact business based on the determination that at least one of the one or more requirements has not been satisfied.

18. A computer-readable medium encoded with a computer program comprising instructions that when executed cause one or more processors to:
receive a security profile associated with and configurable by a card party, wherein the security profile comprises one or more requirements;
store the security profile in the database;
receive a request to activate a transaction card;
determine whether the request satisfies the security profile's one or more requirements;
activate the transaction card based on the determination that the transaction request satisfies the one or more requirements; and
transmit an indication of the activation of the transaction card.

19. The computer-readable medium of claim 18, wherein the one or more requirements is selected from the group consisting of:
no attempt has previously been made to transact business utilizing the transaction card;
a time delay between time of activation of the transaction card and time of receiving the request to transact business;
a country code;
a merchant identification number; and
a merchant category code.

20-21. (canceled)

22. The computer-readable medium of claim 19, wherein the instructions that when executed cause the one or more processors further to:
receive a request to transact business utilizing the transaction card;
determine whether the request to transact business satisfies security profile's one or more requirements; and
approve the request to transact business based on the determination that the one or more requirements has been satisfied.

23. The computer-readable medium of claim 19, wherein the instructions that when executed cause the one or more processors further to:
receive a request to transact business utilizing the transaction card;
determine whether the request to transact business satisfies security profile's one or more requirements; and
decline the request to transact business based on the determination that at least one of the one or more requirements has not been satisfied.

24. The method of claim 2, wherein the one or more requirements selected is no attempt has previously been made to transact business utilizing the transaction card.

25. The method of claim 2, wherein the one or more requirements selected is the time delay between time of activation of the transaction card and time of receiving the request to transact business.

26. The method of claim 2, wherein the one or more requirements selected is the country code.

27. The method of claim 2, wherein the one or more requirements selected is the merchant identification number.

28. The method of claim 2, wherein the one or more requirements selected is the merchant category code.
